(19) United States
(12) Patent Application Publication
(10) Pub. No.: US 2010/0291438 A1
(43) Pub. Date: Nov. 18, 2010

(54) ELECTRODE MATERIAL, LITHIUM-ION BATTERY AND METHOD THEREOF

(75) Inventors: Dongjoon Ahn, Boulder, CO (US); Myongjai Lee, Boulder, CO (US); Sandeep R. Shah, Pearland, TX (US)

Correspondence Address: FAY SHARPE LLP, 1228 Euclid Avenue, 5th Floor, The Halle Building, Cleveland, OH, 44115, US

(73) Assignee: PDC Energy, LLC

(21) Appl. No.: 12/483,631

(22) Filed: Jun. 12, 2009

Related U.S. Application Data
(60) Provisional application No. 61/178,719, filed on May 15, 2009.

(51) Int. Cl. H01M 4/58; H01M 4/60; C08L 83/04

(52) U.S. Cl. 429/212; 429/231.8; 524/588; 977/753

(57) ABSTRACT

The invention provides an anode comprising a nanocomposite of graphene-oxide and a silicon-based polymer matrix. The anode exhibits a high energy density such as ˜800 mAhg⁻¹ reversible capacity, a superlative power density that exceeds 250 kW/kg, a good stability, and a robust resistance to failure, among others. The anodes can be widely used in a lithium-ion battery, an electric car, a hybrid electromotive car, a mobile phone, and a personal computer etc. The invention also provides a liquid phase process and a solid-state process for making the nanocomposite, both involving in-situ reduction of the graphene-oxide during a pyrolysis procedure.

### CLAIM OF PRIORITY

This application claims priority from Provisional Application No. 61/178,719, filed on May 15, 2009.

### BACKGROUND OF THE INVENTION

The present invention is related to an electrode material, a lithium-ion (Li-ion) battery using the same, and a method of preparing the same. It finds particular application in conjunction with an electric car, a hybrid electromotive car, a mobile phone, and a personal computer, among others; and will be described with particular reference thereto. However, it is to be appreciated that the present exemplary embodiment is also amenable to other like applications.

As a rechargeable battery, a lithium-ion battery includes lithium ions in a liquid electrolyte that move back and forth between the anode and the cathode. The lithium ions move from the anode to the cathode when the battery passes an electric current through an external circuit (i.e. discharging), and move from the cathode to the anode when charging. The cathode material of a lithium-ion battery may be, for example, titanium disulfide, a layered oxide such as lithium cobalt oxide, a polyanion-based material such as lithium iron phosphate, and a spinel such as lithium manganese oxide. The liquid electrolytes in Li-ion batteries typically comprise lithium salts, for example, LiPF₆, LiBF₄, or LiClO₄, in an organic solvent such as ether.

Despite the development of various anode materials, these materials exhibit less than satisfactory properties or performances, or they exhibit a poor balance between different properties and performances. For example, the material most commonly used for an anode in Li-ion batteries is based upon derivatives of graphite, which is known to have a theoretical capacity of 372 mAhg⁻¹. Edward Buiel et al disclosed hard carbon as ananode material in J. Electrochem. Soc., Vol. 145, No. 6, June 1998. However, the hard carbon's irreversible capacity (511 mAhg⁻¹) and reversible capacity (220 mAhg⁻¹) are both low. In a paper published by Masaki Yoshio et al in J. Mater. Chem., Vol 14 1754-1758 2004, sphere graphite was used as the electrode material, but its irreversible capacity and reversible capacity are only 402 mAhg⁻¹ and 364 mAhg⁻¹ respectively. H. Fugimoto et al have explored the use of meso carbon micro beads (MCMB) in J. Power Sources, Vol. 54, 440-443, 1995, however, the irreversible capacity and reversible capacity of MCMB remain as low as 531 mAhg⁻¹ and 325 mAhg⁻¹. Milled mesophase pitch-based carbon fibers (mMPCFs) shows an irreversible capacity of 760 mAhg⁻¹ and a reversible capacity of 350 mAhg⁻¹ in M. Endo et al, Carbon, Vol. 37, 561-568, 1999. Ti (Sn) demonstrates a higher irreversible capacity (1250 mAhg⁻¹) and reversible capacity (1000 mAhg⁻¹), but its cyclic stability is poor, as taught in J. Hassoun et al, Israel Journal of Chemistry, Vol. 48 2008. The cyclic stability of Tin based oxide (SnO₂) is also poor, although the material has an irreversible capacity of 2013 mAhg⁻¹ and a reversible capacity of 1500 mAhg⁻¹ (P. Meduri et al, Nano Letter, Vol. 9 (2) 2009). As known to a skilled person in the art, the cyclic stability is measured as the loss in energy density with the number of charge-discharge cycles. The term “discharge rate” is an indication of the rate at which the anode can be discharged, which can be expressed as XC, wherein X is equal to the inverse of the discharge time in units of hours. For example, X=0.1 implies a discharge time of 10 h, and X=10 a discharge time of 6 min. The power-density of an anode is given by the product of the energy density and the discharge rate. Lithium Titanate exhibits a capacity retention of 85%@10C, but its irreversible capacity and reversible capacity are extremely low, being 165 mAhg⁻¹and 160 mAhg⁻¹ respectively (K. Nakahara et al, J. of Power Sources, Vol 17 2003).

Si-based materials have also been used as the anode material for a lithium-ion battery. For example, Si-based polymers exhibit an irreversible capacity of 1100 mAhg⁻¹ and a reversible capacity of 800 mAhg⁻¹, as disclosed in W. Xing et al, Solid State Ionics, Vol. 93, 239-244 (1997); A. M. Wilson, Solid State Ionics, Vol. 100, 259-266 (1997); W. Xing et al, J. Electrochem. Soc., Vol. 144[7], 2410-2416 (1997); Riedel et al., J. European Ceram. Soc., Vol. 26[16], 3897-3901 (2006); Riedel et al., J. European Ceram. Soc., Vol. 26[16], 3903-3908 (2006); U.S. Pat. Nos. 5,631,106; 5,824,280; 5,907,899; and 6,306,541. Thin film electrodes using a silicon film can demonstrate an irreversible capacity of up to 4277 mAhg⁻¹ and a reversible capacity of up to 3124 mAhg⁻¹, according to C. Chan et al, Nature Nonotechnology, December 2007; and thin film electrodes using a Si—Al film can have an irreversible capacity of up to 4277 mAhg⁻¹, a reversible capacity of up to 3124 mAhg⁻¹, and a C-rate of 5C @ 50% capacity retention, according to L. B. Chen et al, Electrochimica Acta, Vol 53, 2008. Nevertheless, while Si has a very high capacity, it does not perform well in other areas.

Recently, composites made from graphene nanosheets (GNS) combined with various particulates have been studied as anode materials. The particulates including carbon C60 & carbon nanotubes (Yoo et al, Nano Lett., Vol. 8[8], 2277-2282 2008), tin-oxide (Paek et al., Nano Lett., Vol. 9[1], 72-75 2009) and titanate powders (Watanabe et al., Abstract, 214^{th} ECS Conference, 2008) have been reported as anode materials. These materials possess discharge capacity of up to 1000 mAhg⁻¹, but the capacity degrades rapidly with the number of cycles.

Advantageously, the present invention provides an anode material such as nanocomposites made from graphene-oxide (GO) and silicon based polymers, a Li-ion battery using the same, and a method of preparing the same. In addition to that the method of the invention is a safer and more environmentally friendly process, the anodes of the invention exhibit numerous technical merits, for example, a high energy density such as ˜800 mAhg⁻¹ reversible capacity, a superlative power density that exceeds 250 kW/kg, a high stability, and a robust resistance to failure, among others.

### BRIEF DESCRIPTION OF THE INVENTION

One aspect of the invention provides an electrode material comprising a nanocomposite of graphene-oxide and a silicon-based polymer matrix.

Another aspect of the invention provides a lithium-ion battery including an anode comprising a nanocomposite of graphene-oxide and a silicon-based polymer matrix.

Still another aspect of the invention provides a method of preparing a nanocomposite of graphene-oxide and a polymer matrix, which comprises:
(i) providing a liquid polymeric precursor;
(ii) providing graphene-oxide;
(iii) mixing the liquid polymeric precursor and the graphene oxide;
(iv) cross linking such as thermally cross linking the liquid mixture; and
(v) pyrolyzing the mixture in an inert atmosphere at temperatures of up to 1100° C.

A further aspect of the invention provides a method of preparing a nanocomposite of graphene-oxide which comprises:
(i) providing a solid polymer;
(ii) milling the solid polymer with graphene oxide; and
(iii) pyrolyzing the milled mixture in an inert atmosphere at temperatures of up to 1100° C.

### BRIEF DESCRIPTION OF THE DRAWINGS

FIG. 1 schematically shows the nanocomposite structure of an anode including graphene-oxide sheets distributed in a polymer-derived matrix, according to an embodiment of the invention;

FIG. 2 is the plot of the cyclic stability in term of specific capacity (mAh/g) and the coulombic efficiency (%) of anodes tested under a 0.01V˜3.0V voltage-window, according to an embodiment of the invention;

FIG. 3 shows the measured discharge rate capability of anodes after charging at 100 mA/g current density with 0.01˜3.0V voltage window as the C-rate was increased from 0.2 C (or C/5) to 22 C, according to an embodiment of the invention;

FIG. 4a shows the capacity retentions of anodes as compared with a control under 0.01˜2.5V voltage window as a function of C-rate in a range up to 1000 C, according to an embodiment of the invention;

FIG. 4b shows the capacity retentions of anodes as compared with a control under 0.01˜2.5V voltage window as a function of C-rate in a range up to 100 C, according to an embodiment of the invention;

FIG. 5 shows the discharge capacities of anodes under different current density states with 0.01˜2.5V voltage window, according to an embodiment of the invention; and

FIG. 6 shows the power density of anodes as a function of C-rate with 0.01-2.5V voltage window, according to an embodiment of the invention.

### DETAILED DESCRIPTION OF THE INVENTION

In various embodiments, the present invention provides an electrode material, particularly an anode material for a Li-ion battery, which comprises a nanocomposite of graphene-oxide and a silicon-based polymer matrix. In the electrode material, the graphene oxide may comprise from about 0.01% to about 50.00% by weight and the silicon-based polymer 99.99 to about 50.00% by weight based on the total weight of the nanocomposite.

In preferred embodiments, the silicon-based polymer is a pyrolyzed silicon-based polymer. The silicon-based polymer may comprise silicon and at least three elements selected from oxygen, nitrogen, carbon and hydrogen. For example, the silicon-based polymer may have a general formula of SiCₓN_{y}O_{z}Hₘ, wherein x=0.7-2, y=0-0.8, z=0-0.85, and m=0-5.

The electrode material of the invention may also contain any other suitable components, for example, a binder. In exemplary embodiments, the electrode material contains less than 95% by weight of the nanocomposite, and the remainder is the binder; for example, from about 70% to about 95% by weight of the nanocomposite and from about 5% to about 30% by weight of the binder. Another suitable component in the electrode material according to the present invention is a carbon based conducting agent such as acetylene black. Generally, the conducting agent is not in the nanocomposite with a silicon-based polymer matrix.

In a specific embodiment, the electrode material contains from about 70% to about 95% by weight of the nanocomposite; from about 5% to about 30% by weight of the binder; and from about 0% to about 30% by weight of the carbon based conducting agent. In another specific embodiment, the electrode material contains from greater than zero to less than 80% by weight of nanocomposite, from greater than zero to less than 20% by weight carbon based conducting agent, and the remainder is the binder.

The present invention further provides a lithium-ion battery including an anode having the electrode material as described above. Anodes for lithium-ion batteries are constructed from nanocomposites of graphene-oxide and polymer hybrids. For simplicity, these nanocomposite-anodes made from graphene-oxide (GO) and the silicon based polymers are called graphene-oxide nanocomposites anodes, or GO-NC-anodes. The GO-NC-anode can exhibit numerous superior performances including: (1) a capacity of about 800 mAhg⁻¹ when the lithium-ion battery cycles at a C rate of C/20 for at least 500 cycles, wherein the term “C rate” is an indication of the rate at which the anode can be discharged, which can be expressed as XC, wherein X is equal to the inverse of the discharge time in units of hours. For example, X=0.1 implies a discharge time of 10 hours, X=10 a discharge time of 6 min, and C/20=0.05 C implies a discharge time of 20 hours; (2) a capacity retention of at least 100 mAhg⁻¹ when the lithium-ion battery cycles at C rate of 100 C for at least 500 cycles; (3) a capacity retention of at least 85% after the lithium-ion battery runs for 1000 cycles under a 0.01V˜3.0V voltage-window at C/5 rate; (4) a capacity retention of at least 90% after the lithium-ion battery runs for 1000 cycles under a 0.01V˜3.0V voltage-window at C/10 rate; (5) a power density of at least 250 kW/kg after the lithium-ion battery runs for at least 100 cycles under a 0.01-2.5 V voltage-window at a rate of 6000 C; and (6) a recovery of at least 95% charge capacity after the lithium-ion battery runs for at least 500 cycles under a 0.01-2.5 V voltage-window at a rate of 2000 C.

The present invention further provides a liquid phase process for preparing a nanocomposite of graphene-oxide and a polymer matrix, which comprises:
(i) providing a liquid polymeric precursor such as siloxanes and silanes, for example, 1,3,5,7-tetramethyl-1,3,5,7-tetravinylcyclotetrasiloxane (TTCS);
(ii) providing graphene-oxide;
(iii) mixing the liquid polymeric precursor and the graphene oxide;
(iv) cross linking such as thermally cross linking the liquid mixture; and
(v) pyrolyzing the mixture in an inert atmosphere at temperatures of up to 1100° C.

In preferred embodiments, the method further comprises a step of in-situ reduction of the graphene oxide into a functionalized form of graphene. For example, the reducing agent may be the pyrolysis products such as hydrocarbons and hydrogen. In optional embodiments, after the cross-linking and pyrolyzing steps, the reduced GO-NC composite can be pulverized using high energy ball or attrition mill. The milled powder is then fabricated as anode by known techniques.

In an embodiment, 1,3,5,7-tetramethyl-1,3,5,7-tetravinylcyclotetrasiloxane (TTCS) was mixed with graphene to prepare the nanocomposite. The product exhibited a reversible energy density of 800 mAh g⁻¹, a cyclic stability to within 95% of the initial value after 100 cycles, and a discharge rate capacity of up to 25 C.

Also provided in the present invention is a solid-state process for preparing a nanocomposite of graphene-oxide which comprises:
(i) providing a solid polymer;
(ii) milling the solid polymer with graphene oxide; and
(iii) pyrolyzing the milled mixture in an inert atmosphere at temperatures of up to 1100° C.

In preferred embodiments, the reduction of the graphene oxide is achieved in-situ during the pyrolysis.

Without being bound by theory, it is believed that the superior performance demonstrated by the present invention is at least partially because the graphene-polymer nanocomposite is prepared by reducing oxidized graphene in-situ. As known to a skilled artisan, exfoliated graphene structures are primarily available in an oxidized state. An oxidation helps to exfoliate the lamellar structure of graphite. However, the oxidation results in making the graphene structure non-conductive. For an effective anode structure, it is vital that this graphene phase be conducting. To that end, the graphene structure is usually reduced using hydrazine hydrate, which is however a toxic chemical with high affinity to oxygen rendering them explosion and fire hazard. The present invention makes differences in two aspects. First, the invention processes a hybrid consisting of an oxidized graphene structure dispersed evenly in a silicon-based polymeric precursor such as siloxanes, silanes, or others. Upon heating these polymers to a high temperature such as a range of 600-800° C., the material tends to evolve hydrocarbons and hydrogen. This creates a reducing environment that removes oxygen from the oxidized graphene and makes it conductive. Secondly, when the oxidized graphene is reduced, it tends to de-exfoliate, i.e., graphene layers start coming close to each other and make small graphitic phases. However, the presence of silicon based polymer around the graphene sheets prevents them from clustering together. This allows the reduced conducting graphene phase to form a stable hybrid structure. The interface between the graphene and the polymer tends to act as the reaction site for Li-ions to transfer charge within the anode. Since this interface is crated at nanoscale, it provides high specific area for reaction and thereby results in anode with extremely high specific charge capacity.

For example, exfoliated graphene and silicon based polymer precursor are dispersed in a solvent such as acetone with or without surfactant such as Triton 100X. The dispersed solution is crosslinked thermally, catalytically or under electromagnetic radiation such as light, gamma rays, neutron beams and others. This results in the phase change of the polymer, turning it into epoxy like solid. The crosslinking can be performed in a die, to obtain the final shape of the anode, or if necessary, it can be pulverized and compacted again to form a required shape. The later step may help to get better dispersion of the conducting phase in the non-conducting silicon based polymer. Fine particulate may be synthesized by high energy mechanical ball milling with zirconia or other appropriate grinding media. After high energy ball milling, the powder is heat treated under an inert atmosphere such as argon or nitrogen gas. The heat treat temperature range can be from 600° C. to 1000° C. In an embodiment, 800° C. heat treatment worked well as it possesses optimum amount of hydrogen in the silicon structure to produce a hybrid with excellent charge storage and fast charging and discharging cycle capability, as disclosed in G. D. Soraru, L. Pederiva, J. Latournerie and R. Raj, J. AM. CERAM. SOC., Vol. 85 [9] 2181-7 (2004), which is incorporated herein by reference in its entirety. Also, at this temperature, enough hydrogen and hydrocarbons evolve from the polymer to reduce the oxidized graphene completely. The presence of hydrogen also retains amorphous phase of the polymer. In the absence of hydrogen, the polymer turns into ceramic and crystallize resulting in particulate microstructure, which can reduce the specific surface area and thereby the specific capacity of the anode.

For some siloxanes, silanes and other silicon based polymers, it may not be possible to disperse the oxidized graphene in liquid state, either due to unavailability of proper solvent for the polymer and surfactant, or the reactivity of the liquid with the graphene suspension or to graphene itself. Under this circumstance, the solid-state process may be used, wherein the polymer is cross-linked by itself into a solid. The solid is then milled into powder using conventional ball mill, planetary mill or attrition mill. The milled powder can then be mixed with oxidized graphene suspension or dried powder. This mixture can then be attrition milled together. The attrition milling works by shearing action. This allows the layers of graphene to be coated with layers of polymeric powder. It is contemplated that this technique may be extrapolated to natural flaked graphite or other lamellar graphitic structure. High energy attrition mill can separate out the layers of such graphitic material and embed them with polymeric powder between the layers, resulting in hybrid polymer-graphene structure. The attrition milling is normally conducted in a liquid medium such as acetone or alcohol, for better dispersion of heat and prevention of the coagulation of the powders. The hybrid powder can be isolated from the liquid medium using a rotary evaporator. This hybrid powder can then be heat treated in the temperature range of 600-1000° C. to produce optimum hydrogen concentration for polymeric structure. Also this heat treatment is necessary in case of oxidized graphene, to reduce it in-situ to produce the hybrid structure. The powder route provides particulate reinforcement between the graphene layers. This kind of structure may be desirable in some Li-ion anodes, where Li poisoning of anode results in failure of the battery. The particulate structure may absorb Li ions and isolate them, preventing the failure of the battery.

### EXAMPLE 1

### Preparation of Electrode Material by Liquid-Phase Process

Two different processing routes were used to synthesize the anode material in Examples 1 and 2. Example 1 was a liquid phase process, and that in Example 2 was a solid-state process. In both processes, the graphene oxide was fabricated by a usual method disclosed in W. Hummers, J. AM. CHEM. SOC., Vol. 80 [6] (1958), which is incorporated herein by reference in its entirety.

The graphene oxide was mixed with a liquid phase TTCS and a peroxide catalyst such as dicumyl peroxide, in a weight ratio of graphene oxide:precursor:catalyst=5˜50: 95˜50: 1˜5 with 1˜5% peroxide catalyst. The mixture was then kept in ultra-sonic bath followed by high speed shear homogenizer to produce good dispersion. After the dispersion process, the liquid suspension was crosslinked in an argon purged vertical tube furnace for about 1 to 5 hours at a temperature from 200° C. to 400° C. Then, it was pyrolyzed at a higher temperature in the argon purged furnace for about 3 hours to 10 hours. The pyrolysis temperature range was from about 700° C. to 1000° C.

### EXAMPLE 2

### Preparation of Electrode Material by Solid-State Process

The graphene oxide was mixed with a crosslinked polymer powder, which was made from TTCS and peroxide catalyst in a weight ratio of graphene oxide: crosslinked polymer powder of from about 5:95 to about 50:50. Crosslinking process was performed in the argon purged vertical tube furnace from 200° C. to 400° C.

Then the mixture was ground in an attrition mill for about 5 to 20 hours with a liquid medium such as acetone or methyl alcohol to dissipate the heat and avoid burning. The attrition milling was performed using zirconia balls. Subsequently, the milled powder in the liquid medium was dried in the convection oven for about 1 to 10 hours followed by pyrolysis at an elevated temperature in the argon purged furnace for about 3 to 10 hours. The pyrolysis temperature range was from about 700° C. to 1000° C.

### EXAMPLE 3

### Electrode and Half Cell

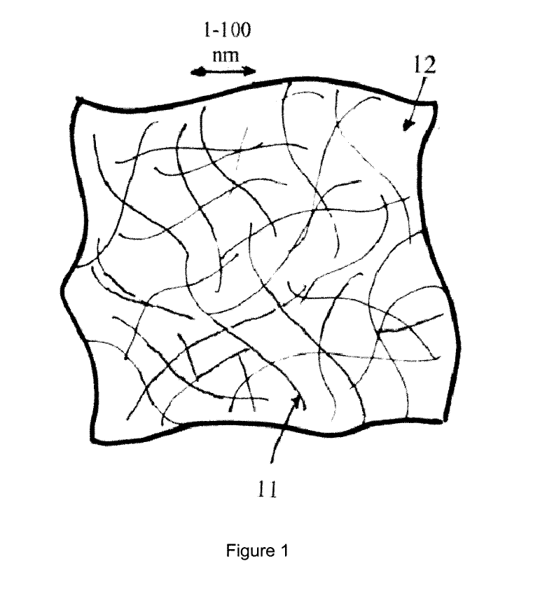

GO-NC-Anodes were prepared using two methods. Some anodes were prepared using mixtures comprising by weight 80% active material for Example 1 or Example 2, 10% Acetylene Black, and 10% polyvinylidene fluoride (PVDF) as a slurry in 1-methyl-2-pyrrolidinone. Some anodes were prepared using mixtures comprising by weight 90% active material and 10% PVDF as a slurry in 1-methyl-2-pyrrolidinone. Then the mixtures were spreaded onto copper foil using the screen printing method with a 5 mil applicator. As will be evidenced in Examples 5-9, both methods have produced similar properties in the anodes. Without the intention to be bound by any particular theory, it is envisioned that both methods have produced a nanocomposite structure of GO-NC-Anodes as schematically shown in FIG. 1. With reference to FIG. 1, graphene-oxide sheets 11 are distributed in a polymer-derived matrix 12 made from SiCₓN_{y}O_{z}Hₘ, wherein x=0.7-2, y=0-0.8, z=0-0.85, and m=0-5.

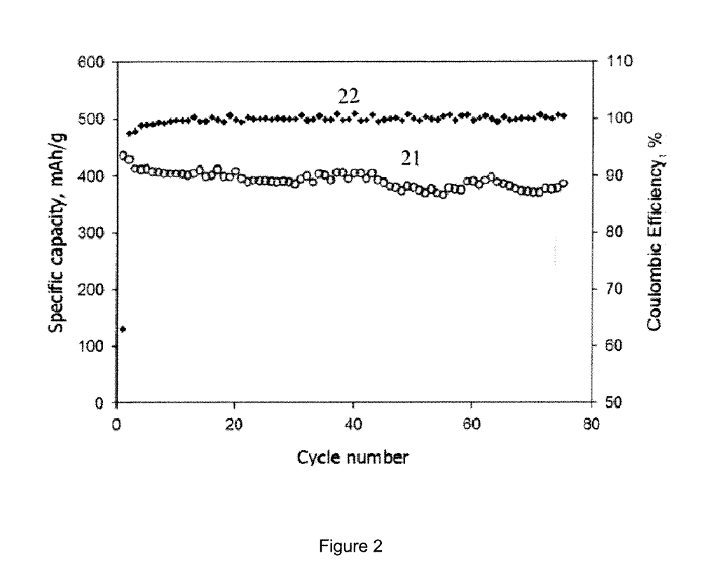

A half-cell was constructed in layers with a pure lithium foil at bottom, a polymer separator and the anode material on top. For testing, LiPF₆ in ethylene carbonate and dimethyle carbonate was used as the battery electrolyte. Specifically, a half cell was constructed with the prepared electrode serving as the working electrode in a 2324-type coin cell, and a lithium foil disk was used as the counter and reference electrodes. Polymer membrane which was composed of polypropylene and polyethylene and 1 M LiPF₆ in a mixed solution of ethylene carbonate and diethyl carbonate (volume ratio 1:1) were used as the separator and the electrolyte, respectively. The coin-cells were assembled, crimped and closed in an argon filled glove box and were tested with rechargeable battery (BT 2000, Arbin Instrument) following an usual procedure. The performances of the anodes were measured and described in Examples 4-8 and FIGS. 2-6.

### EXAMPLE 4

### Cyclic Stability and Coulombic Efficiency

FIG. 2 is the plot of the cyclic stability in term of specific capacity (mAh/g) and the coulombic efficiency (%) of GO-NC-Anodes tested under a 0.01V˜3.0V voltage-window. With reference to FIG. 2, data points 21 are the specific capacities as a function of the cycle number, and data points 22 are the coulombic efficiencies as a function of the cycle number. As graphite is known to have a theoretical capacity of 372 mAhg⁻¹, FIG. 2 demonstrates that the products of the invention have a better stability of the energy density for up to 75 cycles, measured as a C-rate of 0.2 C. FIG. 2 also demonstrates that the coulombic efficiency, which is the ratio of the charge to discharge capacity, remains near 100% after 75 cycles.

### EXAMPLE 5

### Discharge Rate Capability

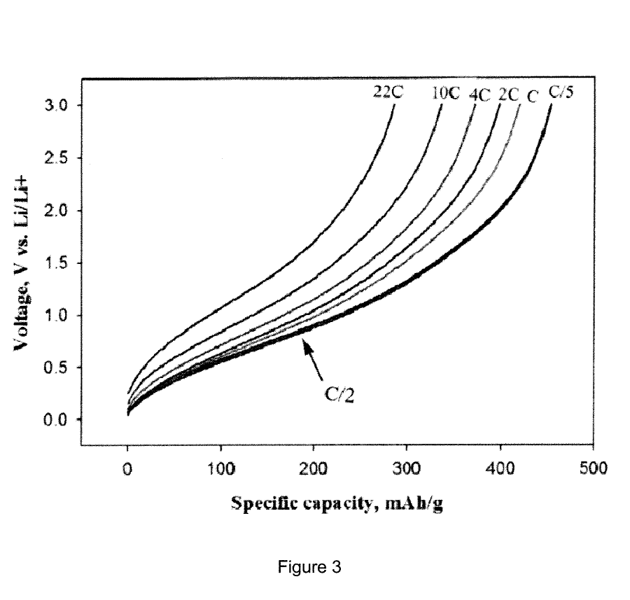

FIG. 3 shows the measured discharge rate capability of the anodes after charging at 100 mA/g current density with 0.01V˜3.0V voltage window as the C-rate was increased from 0.2 C (or C/5) to 22 C. FIG. 3 demonstrates the change in the capacity when the anode is discharged at higher and higher rates. In all these tests the charging rate was kept constant at 100 mA/g, while the discharging rate was progressively increased. The discharge curves in FIG. 3 prove that there is approximately a 50% drop in the capacity, which is better than any other anode materials as reported in K. Lee et al, Adv. Funct. Mater. (2005).

### EXAMPLE 6

### Capacity Retention

In this example, anodes constructed from carbonaceous material graphite and MCMB were used as a control for comparison.

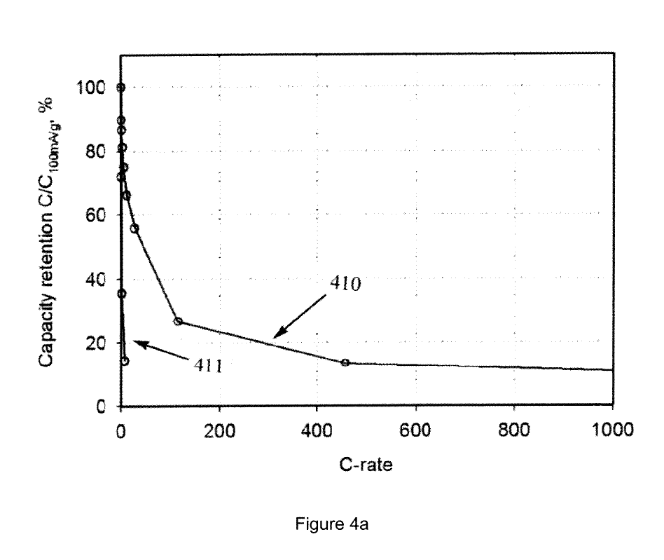

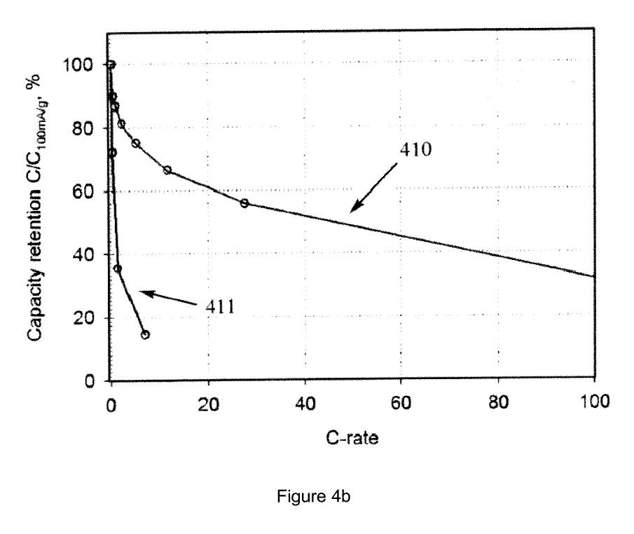

FIG. 4a shows the capacity retentions of the anode from Example 3 as compared with the control under 0.01V˜2.5V voltage window as a function of C-rate in a range up to 1000C. FIG. 4b is the magnified portion of FIG. 4a in the C-rate of 0-100 C.

Similar to FIG. 3, FIGS. 4a and 4b show the change in the capacity when the anode was discharged at higher and higher rates. In all these tests, the charging rate was kept constant at 100 mA/g, while the discharging rate was progressively increased. With reference to FIGS. 4a and 4b, curves 410 are the capacity retention of the anode from Example 3 as a function of C-rate, and curves 411 are the capacity retention of the control anode as a function of C-rate.

As disclosed in L. Bazin et al, J. Power Sources, 188 (2009), the control in this example is known to have the state-of-the-art anode performance for Li ion batteries. However, FIGS. 4a and 4b demonstrate that the control failed at rates greater than about 10 C, but the anode of Example 4 failed after a much higher rate. In other words, the C-rate results for GO-NC-Anodes of the invention far exceed the state-of-the-art anode performance for Li ion batteries in prior arts.

### EXAMPLE 7

### Discharge Capacity

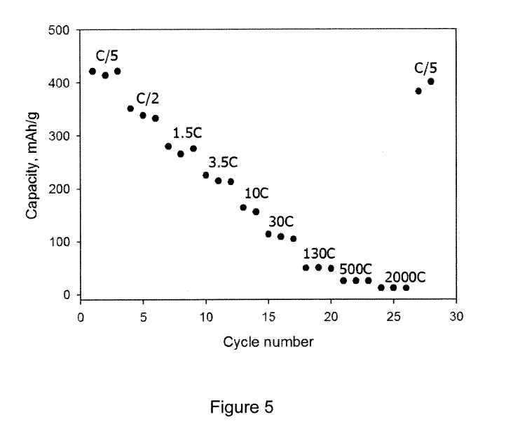

FIG. 5 shows the discharge capacities of the GO-NC-Anodes from Example 3 under different current density states with 0.01V˜2.5V voltage window. Charge/discharge current was applied the same in each 3 cycles. The legend “C/n” in FIG. 5 denotes the rate at which a full charge or discharge takes n hours.

FIG. 5 demonstrates the high resistance of the GO-NC-Anodes to failure even when exposed to 2000 C in symmetrical cycles, that is, where the rates used for charging is equal to the rate used for discharging. Therefore, at 2000 C the anode was fully charged in 1.8 seconds, and discharged in 1.8 seconds. In this example, the capacity is smaller than the results for the asymmetrical cycles shown in FIGS. 4a and 4b. The most significant aspect of these results is that even when forced to charge/discharge at 2000 C, the anode recovers fully when the charge rate is restored to 0.2 C (or C/5). These data show that the anode is robust and does not fail even under the most severe loading conditions.

### EXAMPLE 8

### Power Density

The product of the energy density, the average voltage and the C-rate provides a measure of the power density for the anode, according to the following equation.

Power Density=Q×C×V Eq. (1)

where Q is the specific capacity, Ah/g; C is the C-rate (1/h); and V is the operating voltage.

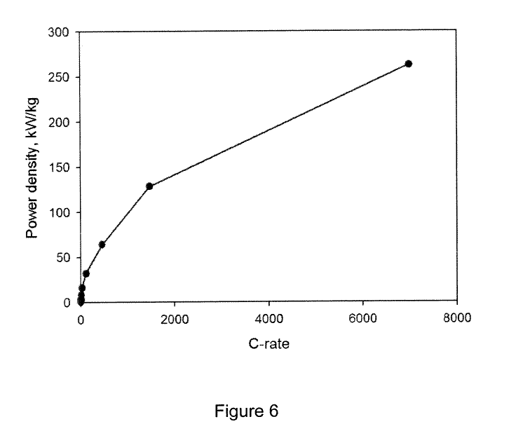

The data in FIGS. 4a, 4b, and 5, when inserted into Eq. (1), give the power density of the anode as a function of the C-rate, as shown in FIG. 6.

FIG. 6 shows the power density of the GO-NC-Anode of Example 3 as a function of C-rate with 0.01-2.5V voltage window. The results in FIG. 6 demonstrate that an up to 250 kW/kg power density is achieved. This value is 100 to 1000 times greater than the power density in the prior art.

The exemplary embodiments have been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An electrode comprised of a nanocomposite of graphene-oxide and a silicon-based polymer matrix.

2. The electrode according to claim 1, wherein the electrode is an anode.

3. The electrode according to claim 1, wherein the graphene oxide comprises from about 0.01% to about 50.00% by weight based on the total weight of the nanocomposite.

4. The electrode according to claim 1, wherein the silicon-based polymer is a pyrolyzed silicon-based polymer.

5. The electrode according to claim 1, wherein the silicon-based polymer comprises silicon and at least three elements selected from oxygen, nitrogen, carbon and hydrogen.

6. The electrode according to claim 5, wherein the silicon-based polymer has a general formula of SiCₓN_{y}O_{z}Hₘ, wherein x=0.7-2, y=0-0.8, z=0-0.85, and m=0-5.

7. The electrode according to claim 1, further comprising a binder.

8. The electrode according to claim 7, which contains from about 70% to about 95% by weight of the nanocomposite and from about 5% to about 30% by weight of the binder.

9. The electrode according to claim 8, which contains less than 95% by weight of the nanocomposite, and the remainder is the binder.

10. The electrode according to claim 8, further comprising a carbon based conducting agent.

11. The electrode according to claim 10, wherein the carbon based conducting agent that is not in the nanocomposite with a silicon-based polymer matrix.

12. The electrode according to claim 1, which contains from about 70% to about 95% by weight of the nanocomposite; from about 5% to about 30% by weight of the binder; and from about greater than 0% to about 30% by weight of the carbon based conducting agent.

13. The electrode according to claim 9, which contains less than 80% by weight of nanocomposite, less than 20% by weight carbon based conducting agent such as acetylene black, and the remainder is the binder.

14. A lithium-ion battery including an anode including the electrode of claim 1.

15. The lithium-ion battery according to claim 14, wherein the anode exhibits a capacity of about 800 mAhg⁻¹ when the lithium-ion battery cycles at C rate of C/20 for at least 500 cycles.

16. The lithium-ion battery according to claim 14, wherein the anode exhibits a capacity retention of at least 100 mAhg⁻¹ when the lithium-ion battery cycles at C rate of 100C for at least 500 cycles.

17. The lithium-ion battery according to claim 14, wherein the anode exhibits a capacity retention of at least 85% after the lithium-ion battery runs for 1000 cycles under a 0.01V˜3.0V voltage-window at C/5 rate.

18. The lithium-ion battery according to claim 14, wherein the anode exhibits a capacity retention of at least 90% after the lithium-ion battery runs for 1000 cycles under a 0.01V˜3.0V voltage-window at C/10 rate.

19. The lithium-ion battery according to claim 14, wherein the anode exhibits a power density of at least 250 kW/kg after the lithium-ion battery runs for at least 100 cycles under a 0.01-2.5 V voltage-window at a rate of 6000 C.

20. The lithium-ion battery according to claim 14, wherein the anode exhibits a recovery of at least 95% charge capacity after the lithium-ion battery runs for at least 500 cycles under a 0.01-2.5 V voltage-window at a rate of 2000 C.

21. A method of preparing a nanocomposite of graphene-oxide and a polymer matrix, which comprises: (i) providing a liquid polymeric precursor; (ii) providing graphene-oxide; (iii) mixing the liquid polymeric precursor and the graphene oxide; (iv) cross linking such as thermally cross linking the liquid mixture; and (v) pyrolyzing the mixture in an inert atmosphere at temperatures of up to 1100° C.

22. The method according to claim 21, further comprising a step of in-situ reduction of the graphene oxide into a functionalized form of graphene.

23. A method of preparing a nanocomposite of graphene-oxide which comprises: (i) providing a solid polymer; (ii) milling the solid polymer with graphene oxide; and (iii) pyrolyzing the milled mixture in an inert atmosphere at temperatures of up to 1100° C.

24. The method according to claim 23, wherein the reduction of the graphene oxide is achieved (in-situ) during pyrolysis.
